(19) United States
(12) Patent Application Publication
(10) Pub. No.: US 2009/0136704 A1
(43) Pub. Date: May 28, 2009

(54) DUAL ACID/CATIONIC DYEABLE POLYAMIDE POLYMER FIBERS AND YARNS, METHODS OF MAKING THE SAME, AND TEXTILE ARTICLES INCLUDING DUAL ACID/CATIONIC DYEABLE POLYAMIDE POLYMER FIBERS

(75) Inventor: Sundar Mohan Rao, Chattanooga, TN (US)

Correspondence Address: INVISTA S.ar.l.;Three Little Falls Centre/1052, 2801 Centervile Road, Wilmington, DE, 19808, US

(73) Assignee: INVISTA North America S. a r. I., Wilmington, DE (US)

(21) Appl. No.: 12/277,606

(22) Filed: Nov. 25, 2008

Related U.S. Application Data
(60) Provisional application No. 60/990,372, filed on Nov. 27, 2007.

(51) Int. Cl. C08G 69/08; C08G 69/14; D04H 11/00

(52) U.S. Cl. 428/97; 528/349; 528/332; 528/323

(57) ABSTRACT

Briefly described, embodiments of this disclosure include fibers, methods of making fibers, structures (e.g., textile articles), and carpets.

### CROSS-REFERENCE TO RELATED APPLICATION

This application claims priority to U.S. provisional application entitled, “DUAL ACID/CATIONIC DYEABLE POLYAMIDE POLYMER FIBERS AND YARNS, METHODS OF MAKING THE SAME, AND TEXTILE ARTICLES INCLUDING DUAL ACID/CATIONIC DYEABLE POLYAMIDE POLYMER FIBERS,” having Ser. No. 60/990,372, filed on Nov. 27, 2007, which is entirely incorporated herein by reference.

### BACKGROUND

Carpets can be constructed using one or more methods. One method is to insert yarn through a primary backing structure (woven or non-woven materials) or fabric to form tufts of the yarn to extend from the pile side of the primary backing structure. The other side (underside) of the primary backing structure has backstitches of the yarn extending from the primary backing that holds the yarn. Subsequently the carpet is dyed, and then a layer of coating material is disposed on the underside. A secondary backing can be applied to the underside to form a backing structure.

Carpets made from polymer yarns, and particularly polyamide yarns such as nylon, are popular floor coverings for residential and commercial applications. Such carpets are relatively inexpensive and have a desirable combination of qualities, such as durability, aesthetics, comfort, safety, warmth, and quietness. Further, such carpets are available in a wide variety of colors, patterns, and textures. Polymer, and particularly polyamide, yarns are preferred for carpeting because they can be dyed easily with acid or other types of dyes. In addition, random or irregular multicolor carpets are very popular especially for commercial carpets.

Multicolored carpets are made in a number of ways. One way is to make solution dyed or pigmented yarns of different colors and tuft them into a carpet in different patterns. But this requires maintaining an inventory of a large number of colored yarns.

The multicolored carpet via dyeing is traditionally made from multicolored yarns produced through an expensive skein dyeing or knit-de-knit space dye process. In skein dyeing, large, loosely wound skeins of yarn are placed in a vat for dyeing. Space dyeing refers to a method of dyeing yarn with multiple colors dyed on each strand. Such processes can produce a variety of visually appealing effects in carpets, including well differentiated color points in an unorganized design. However, the processes are slow and inefficient, which adds to the high cost of such products.

A preferred way to make multicolored carpet is to tuft a variety of yarns of differing dye affinities into a carpet and dye the carpet in a dye bath via processes such as beck dyeing. If light, medium, or deep acid dyeing yarns are combined in a carpet and the carpet is dyed with acid dyes, the carpet shows only tonal differences in the same color and may not be aesthetically pleasing. A better way to produce a multi-color carpet with improved color differentiation is to tuft cationic dyeable yarns along with acid dyeable yarns and dye the carpet in a dye bath with a mixture of acid and cationic dyes. This results in significantly differentiated color patterns on the carpet. However, traditionally, the cationic dyeable fiber is made to reject or only minimally accept acid dyes in order to maintain differentiation in color across the various yarns. In the same way, the acid dyeable yarns are made to reject or only minimally accept cationic dyes. However, this limits the number of colors one can have in a carpet via beck dyeing.

### SUMMARY

Briefly described, embodiments of this disclosure include fibers, methods of making fibers, structures (e.g., textile articles), and carpets. One exemplary fiber, among others, includes: a dual acid/cationic dyeable polyamide polymer fiber having an acid dyeable moiety and a cationic dyeable moiety, wherein the acid dyeable moiety is an amine group, wherein the cationic dyeable moiety is a SO₃ group, wherein the amine group is at a level of about 20 to 60 equivalents/million (mm) grams of polymer, and wherein the SO₃ group is at a level of about 3.5 to 36 equivalents/mm grams of polymer.

One exemplary structure, among others, includes: a textile article that includes one or more types of fibers attached thereto, wherein at least one fiber type is a dual acid/cationic dyeable polyamide polymer fiber having an acid dyeable moiety and a cationic dyeable moiety, wherein the acid dyeable moiety is an amine group, wherein the cationic dyeable moiety is a SO₃ group, wherein the amine group is at a level of about 20 to 60 equivalents/million (mm) grams of polymer, and wherein the SO₃ group is at a level of about 3.5 to 36 equivalents/mm grams of polymer.

One exemplary carpet, among others, includes: a backing structure having one or more types of fibers attached thereto, wherein at least one fiber type is a dual acid/cationic dyeable polyamide polymer fiber having an acid dyeable moiety and a cationic dyeable moiety, wherein the acid dyeable moiety is an amine group, wherein the cationic dyeable moiety is a SO₃ group, wherein the amine group is at a level of about 20 to 60 equivalents/million (mm) grams of polymer, and wherein the SO₃ group is at a level of about 3.5 to 36 equivalents/mm grams of polymer.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, fabrics, textiles, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

As used herein, the term “fiber” refers to filamentous material that can be used in fabric and yarn as well as textile fabrication. One or more fibers can be used to produce a fabric or yarn. The yarn can be fully drawn or textured according to methods known in the art.

As used herein, the term “textile article” includes, but is not limited to, carpets, apparel, furniture coverings, drapes, automotive seat covers, and the like.

As used herein, the term “carpet” may refer to a structure including a primary backing having a yarn tufted through the primary backing. The underside of the primary backing can include one or more layers of material (e.g., coating layer, a secondary backing, and the like) to cover the backstitches of the yarn.

As used herein, the term “primary backing” and/or the “secondary backing layer” may refer to woven or non-woven materials. The woven materials may be natural materials or synthetic materials. The woven materials can include, but are not limited to, cotton, rayon, jute, wool, polyolefins (e.g., polypropylene and polyethylene), polyester, and/or polyamide. The non-woven materials can include fibers such as, but not limited to, polypropylene, rayon, polyethylene, polyester, polyamide, and combinations thereof, blends thereof, and the like.

As used herein, the term “backing” refers to the primary backing, secondary backing, coating layer, combinations thereof, and the like.

### Discussion

Embodiments of the present disclosure provide for dual acid/cationic dyeable polyamide polymer fibers and yarns, methods of making dual acid/cationic dyeable polyamide polymer fibers, textile articles including dual acid/cationic dyeable polyamide polymer fibers, carpets including dual acid/cationic dyeable polyamide polymer fibers, and the like. Embodiments of the present disclosure include textile articles that include a dual acid/cationic dyeable polyamide polymer fiber and yarn (hereinafter “dual acid/cationic dyeable polyamide polymer yarn”) to produce a multicolored article.

It should be noted that traditional cationic dyeable yarns are made to not accept or to only minimally accept acid dyes to maintain differentiation in color across the various yarns. Similarly, acid dyeable yarns are made to not accept or to only minimally accept cationic dyes (“cat dyes”) to maintain differentiation in color across the various yarns.

Unlike traditional yarns, embodiments of the dual acid/cationic dyeable polyamide polymer yarn accept both acid and cationic dyes. Unlike traditional yarns, the dual acid/cationic dyeable polyamide polymer yarn can have a color that is not obtainable using acid dyeable or cationic dyeable yarns alone, which is described in more detail in the Examples. It is well known that acid and cat dyes partition themselves differently across different fibers. In addition, it is known that an acid and a cat dye each migrate differently across different fibers with a different affinity, and this phenomenon is very difficult to predict when both acid and cat dyes are present together in one dye bath. Embodiments of the dual acid/cationic dyeable polyamide polymer yarn resulted in a surprisingly highly differentiated yarn color from that of the acid dyeable or cationically dyeable yarn. Thus, embodiments of the present disclosure are advantageous over traditional yarn coloring approaches. Embodiments of the present disclosure show the result of the different colors that can be produced that were not able to be obtained using traditional yarn.

In an embodiment, the dual acid/cationic dyeable polyamide polymer yarn is tufted along with acid dyeable yarns and/or cat dyeable yarn into a textile article such as a carpet, where the textile article is dyed with a mixture of acid and cat dyes. Embodiments of the present disclosure provide textile articles having more differentiated color patterns in the textile article compared to a textile article made with only acid dyeable and cat dyeable yarns, and which can not be obtained with only acid and cat dyable yarns. Embodiments of the dual acid/cationic dyeable polyamide polymer yarn are dyed by the acid dye as well as cat dye, which thereby provides a color that is different from either the acid dye or cat dye. In other words, the dual acid/cationic dyeable polyamide polymer yarn results in new colors that can be introduced in the textile article with no changes to the dye process or cost of dyeing, which is highly advantageous. Embodiments of the present disclosure provide the ability to create different color textile articles or textile articles with different colors or shades or colors not obtainable via acid and cat dyeable yarns. In embodiments, the different colors may be attributable to the dual acid/cationic dyeable polyamide polymer yarn. In embodiments, the different colors may be attributable to the combination of one or more of the dual acid/cationic dyeable polyamide polymer yarn and/or one or more acid dyeable and cat dyeable yarns.

Embodiments of the dual acid/cationic dyeable polyamide polymer yarn include an acid dyeable moiety and a cationic dyeable moiety. In an embodiment, the acid dyeable moiety is an amine group and the cationic dyeable moiety is a SO₃ group. The amine group is at a level of about 20 to 60, preferably about 25 to 45, or most preferably about 25 to 38 equivalents/million (mm) grams of polymer. The SO₃ group is at a level of about 0.10% (or about 3.5 equivalents per mm grams of polymer (eq)) to 1% (or about 36 eq), or preferably about 0.60% (about 22 eq) to 0.92% (about 33 eq), or most preferably about 0.60% (about 22 eq) to 0.83% (about 30 eq). The level of amine group and SO₃ group can be any combination of the levels noted above (e.g., (a) the amine group is at about 25 to 38 equivalents/mm grams of polymer and the SO₃ group is about 0.60% (about 22 eq) to 0.83% (about 30 eq), (b) the amine group is at about 20 to 60 equivalents/mm grams of polymer and the SO₃ group is about 0.60% (about 22eq) to 0.92% (about 33 eq), and the like). In an embodiment, the amine group is at about 25 to 32 equivalents/mm grams of polymer and the SO₃ group is about 0.60% (about 22 eq) to 0.83% (about 30 eq).

The term “polyamide” as used herein means the well-known fiber-forming substance that is a long-chain synthetic polyamide. The polyamides can be a homopolymer, copolymer, or terpolymer, or mixtures of polymers. Embodiments of polyamide fibers include, but are not limited to, polyhexamethylene adipamide (nylon 6,6); polycaproamide (nylon 6); polyenanthamide (nylon 7); poly(10-aminodecanoic acid) (nylon 10); polydodecanolactam (nylon 12); polytetramethylene adipamide (nylon 4,6); polyhexamethylene sebacamide homopolymer (nylon 6,10); a polyamide of n-dodecanedioic acid and hexamethylenediamine homopolymer (nylon 6,12); and a polyamide of dodecamethylenediamine and n-dodecanedioic acid (nylon 12,12). In addition, the polyamide can be a copolymer polyamide (e.g., a polyamide polymer derived from two or more dissimilar monomers). In particular, the polyamide fiber is polyhexamethylene adipamide and copolymers thereof.

The copolymer may contain a variety of comonomers known in the art, and in particular, may contain methylpentamethylene diamine and isophthalic acid. In an embodiment, the copolymer content is made with co-monomers methylpentamethylene diamine and isophthalic acid in the molar ratio of about 1:1 and having a total copolymer content of about 1.0% to 5.0% by weight, and preferably about 1.0% to 3.0% by weight, and most preferably about 1.0% to 2.0% by weight. In an embodiment, the polymer or copolymer can also include a variety of additives such as delusterants, pigments, stabilizers, antistatic agents, and the like. In an embodiment, the amine group can be about 25 to 32 equivalents/mm grams of polymer and the SO₃ group can be about 0.60% (about 22 eq) to 0.83% (about 30 eq), and in addition has a copolymer content made with co-monomers methylpentamethylene diamine and isophthalic acid in the molar ratio of about 1:1 and having a total copolymer content of about 1.0% to 5.0% by weight, and preferably about 1.0% to 3.0% by weight, and most preferably about 1.0% to 2.0% by weight. In addition, the polymer or copolymer can also include a variety of additives such as delusterants, pigments, stabilizers, antistatic agents, and the like. It should be noted that any one of the levels of the total content of the co-monomers can be combined with any of the combinations of the amount of amine groups and SO₃ groups noted above (e.g., (a) the amine group is at about 25 to 38 equivalents/mm grams of polymer and the SO₃ group is about 0.60% (about 22 eq) to 0.83% (about 30 eq) and in addition has a copolymer content made with co-monomers methylpentamethylene diamine and isophthalic acid in the molar ratio 1:1 and having a total copolymer content of about 1.0% to 5.0% by weight, (b) the amine group is at about 20 to 60 equivalents/mm grams of polymer and the SO₃ group is about 0.60% (about 22 eq) to 0.92% (about 33 eq) and in addition has a copolymer content made with co-monomers methylpentamethylene diamine and isophthalic acid in the molar ratio 1:1 and having a total copolymer content of about 1.0% to 2.0% by weight, and the like).

In particular, embodiments of the present disclosure include methods of making dual acid/cationic dyeable polyamide polymer yarn. The polymer is made from monomers using a batch production process to make pellets. The polymer in pellet form is then extruded in twin screw extruders and spun into fiber. In the alternative, a continuous production process can be used to convert monomers to polymer and spin directly. In this process, the monomers are polymerized and the polymer is pumped directly to a spinning machine to make yarn.

In either case, the level of SO₃ moiety is adjusted to be in the range specified herein. The level of the SO₃ moiety is performed by controlling the level of 5-sufoisophthalic acid moiety introduced during the polymerization process. The level of amine groups are adjusted to be in the range specified herein by methods used to control amine group in the polymerization process. Such methods include the level of hexamethylene diamine added, the HMD loss control, level of adipic acid added, and the molecular weight control of the fiber. Additional details are described in the Examples.

As mentioned above, embodiments of the present disclosure include textile articles including dual acid/cationic dyeable polyamide polymer yarn. In an exemplary embodiment, the textile article is a carpet that includes dual acid/cationic dyeable polyamide polymer yarn. The carpet can include one or more types of dual acid/cationic dyeable polyamide polymer yarn and/or one or more types of other yarns. The other types of yarns could include one or more types of acid dyeable yarn and/or one or more types of cat dyeable yarn. Acid dyeable yarns and cat dyeable yarns are known in the art.

Acid dyes can dye yarn by bonding to the amine groups (e.g., primary, secondary, and/or tertiary amines) (also referred to as “amine-end”) of the polyamide chains. Cationic dyes can dye yarn by bonding to the sulfonate-groups of the polyamide chains. The yarn can be modified by modifying the chemical moieties of the end groups of the yarn.

The cationic dyes include, but are not limited to, MAXILON® (Ciba Specialty Chemicals, Inc), ASTRAZON® (DyStar Textilfarben), SANDOCRYL® (Clariant), SEVRON® (Crompton & Knowles), and the like. The acid dyes can include, but are not limited to, TECTILON® (Ciba Specialty Chemicals, Inc), TELON® (DyStar Textilfarben), NYLOSAN® (Clariant), NYLANTHREN® (Crompton & Knowles), and the like.

In an embodiment, the carpet can be manufactured by providing one or more types of yarns, tufting the one or more types of yarn (including at least the dual acid/cationic dyeable polyamide polymer yarn) into a backing substrate that forms the basis of a carpet, exhausting dyes on the carpet, then steaming, treating rinsing, and/or drying the carpet. The method of forming the carpet can include one or more additional steps to add additive, rinse, or the like.

The polymers, fibers, yarns, and carpet can include conventional additives. The additives can be added during the preparation of the polymer, formation of the fiber or yarn, and/or during or after the formation of the carpet. Exemplary additives include, but are not limited to, permanent or semi-permanent hydrophilic treatments or finishes, adhesion promoters, antistatics, antioxidants, antimicrobials, delustrants (e.g., titanium dioxide), flameproofing agents, dyestuffs, light stabilizers, polymerization catalysts, matting agents, organic phosphates, light stabilizers, heat stabilizers, stainblockers, reinforcing or non-reinforcing fillers, pigments, and combinations thereof.

### Testing Method

Methods for testing the level of the amine group are similar to those described in U.S. Pat. No. 5,330,834A. In short, the amine group levels can be determined by the method described beginning on page 293 in Volume 17 of the “Encyclopedia of Industrial Chemical Analysis” published by John Wiley & Sons (1973), which is incorporated herein by reference.

### EXAMPLES

Now having described the embodiments of the present disclosure, in general, the following Examples describe some additional embodiments of the present disclosure. While embodiments of present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

A polymer with a specified amine group level and SO₃-group was made. The polymer pellets were solid phase polymerized and fed to a twin screw extruder and spun into fiber. The yarn produced was a standard 4 hole hollowfil fiber 1245 denier (Item MR-09-07-20) yarn with SO₃-group level of 17 an amine group level of 28. The other yarns used in the example were 1245-496, a mid acid dyeable yarn, 1245-497, a deep acid dyeable yarn, and 1245494, a cat dyeable yarn. All these yarns were 4 hole hollowfil. Each of the yarns was made into knit socks and heat set in Superba heat setting process at 265° F. The knit socks were then put in a dye bath and dyed with the following dye mixture:

| | |
|---|---|
| MayoQuest | 0.20% |
| ULTRAGEN132N | 1.00% |

Med. Teal Green C645

| | |
|---|---|
| Yellow 3R | 0.0768 |
| Red 2B | 0.0240 |
| Blue 4R | 0.1433 |

Chameleon C485

| | |
|---|---|
| Yellow GL | 0.060 |
| Red YCN(liquid) | 0.207 |
| Blue NCN | 0.189 |

The values given are in % based on weight of fiber. Med teal green color was made up of acid dyes and Chameleon color was made up of cat dyes. Mayoquest was a sequesterant and Ultragen 132N was an anti-coprecipitant.

The pH of the dye bath was maintained at 6.2 with monosodium phosphate.

The resulting colored knit socks were dried and their color was measured using a hand held Minolta spectrophotometer.

The color measurements were:

| Item # | L | a | b | c | h |
|---|---|---|---|---|---|
| MR-09-07- | 60.10 | −8.76 | 17.75 | 19.79 | 116.2 |
| 20 | | | | | |
| 1245-497 | 37.43 | −5.32 | −5.13 | 7.39 | 223.9 |
| 1245-494 | 46.31 | −1.66 | 20.39 | 20.45 | 94.6 |
| 1245-496 | 46.68 | −6.09 | −3.24 | 6.89 | 208.0 |

It is noted that the new fiber item MR-09-07-20 is much lighter (high L value) and has an “a” value quite different from other yarns and a “b” value also quite different from the acid dyeable yarns. The “c” and “h” values of item MR-09-07-20 are quite different from 1245-494, particularly the “h” value. Visually, the new yarn dyes to a different color than any other yarn in the set tested, but the differential shade created by the new item is also significant. The new yarn color looks unlike any other yarn color in the set. This provides strikingly different multicolor effects in carpet.

### Example 2

A different polymer recipe was used to make the polymer for Example 2. The polymer pellets were solid phase polymerized and fed to a twin screw extruder and spun into fiber. The yarn produced was a standard 4 hole hollowfil fiber 1245 denier (Item MR-09-07-1) yarn with SO₃-group level of 36 and an amine group level of 31. The other yarns used in the example were 1245-496, a mid acid dyeable yarn, 1245-497, a deep acid dyeable yarn, and 1245-494, a cat dyeable yarn. All these yarns were 4 hole hollowfil. Each of the yarns was made into knit socks and heat set in Superba heat setting process at 265° F. The knit socks were then put in a dye bath and dyed with the following dye mixture:

| | |
|---|---|
| MayoQuest | 0.20% |
| ULTRAGEN132N | 1.00% |

Med. Teal Green C645

| | |
|---|---|
| Yellow 3R | 0.0768 |
| Red 2B | 0.0240 |
| Blue 4R | 0.1433 |

Chameleon C485

| | |
|---|---|
| Yellow GL | 0.060 |
| Red YCN(liquid) | 0.207 |
| Blue NCN | 0.189 |

The values given are in % based on weight of fiber. Med teal green color was made up of acid dyes and Chameleon color was made up of cat dyes. Mayoquest was a sequesterant and Ultragen 132N was an anti-coprecipitant.

The pH of dye bath was maintained at 6.2 with monosodium phosphate. The dyeing recipe and conditions were identical to example 1.

The resulting colored knit socks were dried and their color was measured using a hand held Minolta spectraphotometer.

The color measurements were:

| Item # | L | a | b | c | h |
|---|---|---|---|---|---|
| MR-09-07-1 | 52.51 | −4.08 | 21.13 | 21.52 | 100.9 |
| 1245-497 | 35.77 | −4.65 | −5.74 | 7.38 | 231 |
| 1245-494 | 49.47 | −1.75 | 21.15 | 21.22 | 94.7 |
| 1245-496 | 46.15 | −5.44 | −4.17 | 6.85 | 217.4 |

It is noted that the new fiber item MR-09-07-1 is lighter (high L value), but the L value itself is not quite different from 1245-494. The “a”, “b” and “c” values of item MR-09-07-1 are not that different from 1245-494; however, the “h” value is different from 1245-494 yarn. Overall, visually the new yarn dyes to a different color than any other yarn in the set tested.

### Example 3

A different polymer recipe was used to make polymer for Example 3. The polymer pellets were solid phase polymerized and fed to a twin screw extruder and spun into fiber. The yarn produced was a standard 4 hole hollowfil fiber 1245 denier (Item MR-07-08-36-10) yarn with SO₃-group level of 27 and an amine group level of 33. In addition, this yarn had a copolymer content made with co-monomers methylpentamethylene diamine and isophthalic acid in the molar ratio 1:1 and having a total copolymer content at 1.5% by weight. The other yarns used in the example were 1245-496, a mid acid dyeable yarn, 1245-497, a deep acid dyeable yarn and 1245-494, a cat dyeable yarn. All these yarns were 4 hole hollowfil. Each of the yarns was made into knit socks and heat set in Superba heat setting process at 265° F. The knit socks were then put in a dye bath and dyed with the following dye mixture:

| | |
|---|---|
| MayoQuest | 0.20% |
| ULTRAGEN132N | 1.00% |

Med. Teal Green C645

| | |
|---|---|
| Yellow 3R | 0.0768 |
| Red 2B | 0.0240 |
| Blue 4R | 0.1433 |

Chameleon C485

| | |
|---|---|
| Yellow GL | 0.060 |
| Red YCN(liquid) | 0.207 |
| Blue NCN | 0.189 |

The values given are in % based on weight of fiber. Med teal green color was made up of acid dyes and Chameleon color was made up of cat dyes. Mayoquest was a sequesterant and Ultragen 132N was an anti-coprecipitant.

The pH of dye bath was maintained at 6.2 with monosodium phosphate. The dyeing recipe and conditions were identical to example 1.

The resulting colored knit socks were dried and their color was measured using a hand held Minolta spectraphotometer.

The color measurements were:

| Item # | L | a | b | c | h |
|---|---|---|---|---|---|
| MR-07-08- | 50.42 | −6.66 | 5.76 | 8.80 | 139.20 |
| 36-10 | | | | | |
| 1245-497 | 41.38 | −5.06 | −3.43 | 6.11 | 214.1 |
| 1245-494 | 47.84 | −2.61 | 15.26 | 15.48 | 99.6 |
| 1245-496 | 45.05 | −5.49 | −3.12 | 6.31 | 209.5 |

It is noted that the new fiber item MR-07-08-36-10 is lighter (high L value), but the L value itself is not quite different from 1245-494. The “a” value is significantly different from that of 1245-494 as well as from others. The “b” value is significantly different from that of 1245-494 as well as from others. The “c” value of item MR-07-08-36-10 is also significantly different from that of 1245-494 as well as from others. The “h” value is significantly different from 1245-494 yarn as well as from others. Visually, the new yarn dyes to a color that is significantly different from any other yarn color in the set tested. Such a significant distinction in color was unexpected.

### Example 4

The same polymer recipe that was used to make polymer for Example 3 was used for this example. However, in this example, carpet was made and dyed instead of knit socks. The polymer pellets were solid phase polymerized and fed to a twin screw extruder and spun into fiber. The yarn produced was a standard 4 hole hollowfil fiber 1245 denier (Item MR-07-08-36-10) yarn with SO₃-group level of 27 and an amine group level of 33. In addition, this yarn had a copolymer content made with co-monomers methylpentamethylene diamine and isophthalic acid in the molar ratio 1:1 and having a total copolymer content at 1.5% by weight. The other yarns used in the example were 1245-496, a mid acid dyeable yarn, 1245-497, a deep acid dyeable yarn and 1245-494, a cat dyeable yarn. All these yarns were 4 hole hollowfil. A carpet was made of these yarns as follows: each of the yarns was self ply twisted to 4.5 twists per inch, heat set in Superba heat set machine at 265° F., and tufted into carpet with specifications: 1/10″ gauge, 7/32″ pile height, 14 stitches per inch, 32 Oz/square yd weight. The carpet had the following yarn end distribution: 33% or 79 ends were of 1245-496 yarn; 33% or 79 ends were of 1245-497 yarn; 17% or 41 ends were of MR-07-08-36-10 yarn and 17% or 41 ends were of 1245-494 yarn. This carpet was then put in a dye bath and dyed with the following dye mixture:

| | |
|---|---|
| MayoQuest | 0.20% |
| ULTRAGEN132N | 1.00% |

Med. Teal Green C645

| | |
|---|---|
| Yellow 3R | 0.0768 |
| Red 2B | 0.0240 |
| Blue 4R | 0.1433 |

Chameleon C485

| | |
|---|---|
| Yellow GL | 0.060 |
| Red YCN(liquid) | 0.207 |
| Blue NCN | 0.189 |

The values given are in % based on weight of fiber. Med teal green color was made up of acid dyes and Chameleon color was made up of cat dyes. Mayoquest was a sequesterant and Ultragen 132N was an anti-coprecipitant.

The pH of dye bath was maintained at 6.2 with monosodium phosphate. The dyeing recipe and conditions were identical to example 1.

The resulting carpet sample was dried and their color was measured using a hand held Minolta spectraphotometer.

The color measurements were:

| Item # | L | a | b | c | h |
|---|---|---|---|---|---|
| MR-07-08- | 43.33 | −6.63 | 3.91 | 7.69 | 149.5 |
| 36-10 | | | | | |
| 1245-497 | 35.41 | −4.68 | −4.75 | 6.66 | 225.5 |
| 1245-494 | 43.1 | −3.24 | 13.29 | 13.67 | 103.60 |
| 1245-496 | 37.91 | −4.79 | −4.21 | 6.37 | 221.3 |

It is noted that in this carpet, the new fiber item MR-07-08-36-10 is lighter (high L value) than 1245-497 and 1245-496, but the L value itself is not different from 1245-494. The “a” value is significantly different from that of 1245-494 as well as from others. The “b” value is significantly different from that of 1245-494 as well as from others. The “c” value of item MR-07-08-36-10 is also significantly different from that of 1245-494 as well as from others. The “h” value is significantly different from 1245-494 yarn as well as from others. Visually the new yarn dyes to a color that is significantly different from any other yarn color in the carpet tested and the carpet shows distinct multiple colors. Such a distinction in color was unexpected.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

At least the following is claimed:

1. A fiber comprising:
a dual acid/cationic dyeable polyamide polymer fiber having an acid dyeable moiety and a cationic dyeable moiety, wherein the acid dyeable moiety is an amine group, wherein the cationic dyeable moiety is a SO₃ group, wherein the amine group is at a level of about 20 to 60 equivalents/million (mm) grams of polymer, and wherein the SO₃ group is at a level of about 3.5 to 36 equivalents/mm grams of polymer.

2. The fiber of claim 1, wherein the amine group is at a level of about 25 to 45 equivalents/mm grams of polymer, and wherein the SO₃ group is at a level of about 22 to 33 equivalents/mm grams of polymer.

3. The fiber of claim 1, wherein the amine group is at a level of about 25 to 45 equivalents/mm grams of polymer, and wherein the SO₃ group is at a level of about 22 to 30 equivalents/mm grams of polymer.

4. The fiber of claim 1, wherein the amine group is at a level of about 25 to 45 equivalents/mm grams of polymer, and wherein the SO₃ group is at a level of about 3.5 to 33 equivalents/mm grams of polymer.

5. The fiber of claim 1, wherein the amine group is at a level of about 25 to 38 equivalents/mm grams of polymer, and wherein the SO₃ group is at a level of about 22 to 33 equivalents/mm grams of polymer.

6. The fiber of claim 1, wherein the amine group is at a level of about 25 to 38 equivalents/mm grams of polymer, and wherein the SO₃ group is at a level of about 22 to 30 equivalents/mm grams of polymer.

7. The fiber of claim 1, wherein the polyamide polymer fiber is a poly(hexamethylene adipamide) polymer fiber.

8. The fiber of claim 1, wherein the polyamide polymer fiber is a polycaproamide polymer fiber.

9. The fiber of claim 1, wherein the polyamide polymer fiber includes a polyamide selected from the group consisting of: polyhexamethylene adipamide; polycaproamide; polyenanthamide; polydodecanolactam; polytetramethylene adipamide; poly(10-aminodecanoic acid); polyhexamethylene sebacamide homopolymer; a polyamide of n-dodecanedioic acid and hexamethylenediamine homopolymer; and a polyamide of dodecamethylenediamine and n-dodecanedioic acid; and a combination thereof.

10. The fiber of claim 1, wherein the polyamide polymer fiber includes methylpentamethylene diamine and isophthalic acid as co-monomers in a molar ratio of about 1:1 with a total copolymer content of about 1.0% to 5% by weight.

11. The fiber of claim 1, wherein the polyamide polymer fiber includes methylpentamethylene diamine and isophthalic acid as co-monomers in a molar ratio of about 1:1 with a total copolymer content of about 1.0% to 3% by weight.

12. The fiber of claim 1, wherein the polyamide polymer fiber includes methylpentamethylene diamine and isophthalic acid as co-monomers in a molar ratio of about 1:1 with a total copolymer content of about 1.0% to 2% by weight.

13. A carpet, comprising:
a backing structure having one or more types of fibers attached thereto, wherein at least one one type of fiber is a dual acid/cationic dyeable polyamide polymer fiber having an acid dyeable moiety and a cationic dyeable moiety, wherein the acid dyeable moiety is an amine group, wherein the cationic dyeable moiety is a SO₃ group, wherein the amine group is at a level of about 20 to 60 equivalents/million (mm) grams of polymer, and wherein the SO₃ group is at a level of about 3.5 to 36 equivalents/mm grams of polymer.

14. The carpet of claim 13, wherein the backing fabric includes a fiber type selected from the group consisting of: an acid dyeable fiber, a cationic dyeable fiber, and a combination thereof.

15. The carpet of claim 13, wherein the amine group is at a level of about 25 to 45 equivalents/mm grams of polymer, and wherein the SO₃ group is at a level of about 22 to 33 equivalents/mm grams of polymer.

16. The carpet of claim 13, wherein the amine group is at a level of about 25 to 45 equivalents/mm grams of polymer, and wherein the SO₃ group is at a level of about 22 to 30 equivalents/mm grams of polymer.

17. The carpet of claim 13, wherein the amine group is at a level of about 25 to 45 equivalents/mm grams of polymer, and wherein the SO₃ group is at a level of about 3.5 to 33 equivalents/mm grams of polymer.

18. The carpet of claim 13, wherein the amine group is at a level of about 25 to 38 equivalents/mm grams of polymer, and wherein the SO₃ group is at a level of about 22 to 33 equivalents/mm grams of polymer.

19. The carpet of claim 13, wherein the amine group is at a level of about 25 to 38 equivalents/mm grams of polymer, and wherein the SO₃ group is at a level of about 22 to 30 equivalents/mm grams of polymer.

20. The carpet of claim 13, wherein the polyamide polymer fiber is a poly(hexamethylene adipamide) polymer fiber.

21. The carpet of claim 13, wherein the polyamide polymer fiber is a polycaproamide polymer fiber.

22. The carpet of claim 13, wherein the polyamide polymer fiber includes a polyamide selected from the group consisting of: polyhexamethylene adipamide; polycaproamide; polyenanthamide; polydodecanolactam; polytetramethylene adipamide; poly(10-aminodecanoic acid); polyhexamethylene sebacamide homopolymer; a polyamide of n-dodecanedioic acid and hexamethylenediamine homopolymer; and a polyamide of dodecamethylenediamine and n-dodecanedioic acid; and a combination thereof.

23. The carpet of claim 13, wherein the polyamide polymer fiber includes methylpentamethylene diamine and isophthalic acid as co-monomers in a molar ratio of about 1:1 with a total copolymer content of about 1.0% to 5% by weight.

24. The carpet of claim 13, wherein the polyamide polymer fiber includes methylpentamethylene diamine and isophthalic acid as co-monomers in a molar ratio of about 1:1 with a total copolymer content of about 1.0% to 3% by weight.

25. The carpet of claim 13, wherein the polyamide polymer fiber includes methylpentamethylene diamine and isophthalic acid as co-monomers in a molar ratio of about 1:1 with a total copolymer content of about 1.0% to 2% by weight.

26. A structure, comprising:
a textile article that includes one or more types of fibers attached thereto, wherein at least one one type of fiber is a dual acid/cationic dyeable polyamide polymer fiber having an acid dyeable moiety and a cationic dyeable moiety, wherein the acid dyeable moiety is an amine group, wherein the cationic dyeable moiety is a SO₃ group, wherein the amine group is at a level of about 20 to 60 equivalents/million (mm) grams of polymer, and wherein the SO₃ group is at a level of about 3.5 to 36 equivalents/mm grams of polymer.

27. The structure of claim 26, wherein the textile article is selected from the group consisting of: a carpet, apparel, a furniture covering, drapes, and an automotive seat cover.

28. The structure of claim 26, wherein the backing fabric includes a fiber type selected from the group consisting of: an acid dyeable fiber, a cationic dyeable fiber, and a combination thereof.

29. The structure of claim 26, wherein the amine group is at a level of about 25 to 45 equivalents/mm grams of polymer, and wherein the SO₃ group is at a level of about 22 to 33 equivalents/mm grams of polymer.

30. The structure of claim 26, wherein the amine group is at a level of about 25 to 45 equivalents/mm grams of polymer, and wherein the SO₃ group is at a level of about 22 to 30 equivalents/mm grams of polymer.

31. The structure of claim 26, wherein the amine group is at a level of about 25 to 45 equivalents/mm grams of polymer, and wherein the SO₃ group is at a level of about 3.5 to 33 equivalents/mm grams of polymer.

32. The structure of claim 26, wherein the amine group is at a level of about 25 to 38 equivalents/mm grams of polymer, and wherein the SO₃ group is at a level of about 22 to 33 equivalents/mm grams of polymer.

33. The structure of claim 26, wherein the amine group is at a level of about 25 to 38 equivalents/mm grams of polymer, and wherein the SO₃ group is at a level of about 22 to 30 equivalents/mm grams of polymer.

34. The structure of claim 26, wherein the polyamide polymer fiber is a poly(hexamethylene adipamide) polymer fiber.

35. The structure of claim 26, wherein the polyamide polymer fiber is a polycaproamide polymer fiber.

36. The structure of claim 26, wherein the polyamide polymer fiber includes a polyamide selected from the group consisting of: polyhexamethylene adipamide; polycaproamide; polyenanthamide; polydodecanolactam; polytetramethylene adipamide; poly(10-aminodecanoic acid); polyhexamethylene sebacamide homopolymer; a polyamide of n-dodecanedioic acid and hexamethylenediamine homopolymer; and a polyamide of dodecamethylenediamine and n-dodecanedioic acid; and a combination thereof.

37. The structure of claim 26, wherein the polyamide polymer fiber includes methylpentamethylene diamine and isophthalic acid as co-monomers in a molar ratio of about 1:1 with a total copolymer content of about 1.0% to 5% by weight.

38. The structure of claim 26, wherein the polyamide polymer fiber includes methylpentamethylene diamine and isophthalic acid as co-monomers in a molar ratio of about 1:1 with a total copolymer content of about 1.0% to 3% by weight.

39. The structure of claim 26, wherein the polyamide polymer fiber includes methylpentamethylene diamine and isophthalic acid as co-monomers in a molar ratio of about 1:1 with a total copolymer content of about 1.0% to 2% by weight.
